(19) United States
(12) Patent Application Publication
(10) Pub. No.: US 2008/0294549 A1
(43) Pub. Date: Nov. 27, 2008

(54) PROCESSING ELECTRONIC TEARSHEETS

(75) Inventor: Adam Leader, Scarsdale, NY (US)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 11/753,407

(22) Filed: May 24, 2007

(51) Int. Cl. G06Q 40/00

(52) U.S. Cl. 705/39

(57) ABSTRACT

In some implementations, a computer-implemented method includes receiving an offer to pay for advertising to be run in a printed publication according to offer parameters that include a publication time; receiving an acceptance to run the advertising according to the offer parameters; receiving, at a submission time, an electronic tearsheet, the submission time being after the publication time of the advertising; and charging a corresponding advertiser a first amount and paying a corresponding publisher a second amount when the submission time is within a first predetermined period of time of the publication time and when a challenge to the electronic tearsheet has not been received from the advertiser within a second predetermined time after the submission time. The electronic tearsheet can evidence publication parameters associated with the advertising that was run in the printed publication.

### TECHNICAL FIELD

This document relates generally to print advertising.

### BACKGROUND

An advertiser desiring to place an advertisement in a printed publication (a “print ad”) can enter into an agreement with a publisher of the publication. The agreement generally includes the terms associated with the placement the print ad. For example, if a print ad is to be placed in a newspaper, the agreement can specify the dates the print ad is to run, the section in the newspaper to place the print ad, the print ad size, and possibly other parameters.

Because printing publications frequently involves manual processes, human error may lead to a print ad not running according to the terms agreed to between the advertiser and the publisher. For example, the print ad simply may not run at all, the wrong print ad content may be run, or the print ad may be inserted into the wrong section of the publication and/or may be sized incorrectly. Conventionally, a publisher may provide a tearsheet (e.g., a copy of a physical page from the newspaper on which the print ad appeared) to the advertiser as proof that a print ad properly ran in the publication. In some cases, human error leads to an incorrect tearsheet being provided to the advertiser, even though the print ad may have been placed according to the terms of the agreement.

Human error—for example in either causing an incorrect tearsheet to be provided or in failing to run a print ad, running the wrong print ad or running a print ad according to terms other than those that were agreed upon—may cause a loss of revenue to advertisers that could have otherwise resulted from a properly run ad and may diminish goodwill between advertisers and publishers. Furthermore, uncertainty in whether ads ran correctly can cause accounting delays in advertisers being charged and publishers being paid.

### SUMMARY

This document relates generally to print advertising. In some implementations, a computer-implemented method includes receiving an offer to pay for advertising to be run in a printed publication according to offer parameters that include a publication time; receiving an acceptance to run the advertising according to the offer parameters; receiving, at a submission time, an electronic tearsheet, the submission time being after the publication time of the advertising; and charging a corresponding advertiser a first amount and paying a corresponding publisher a second amount when the submission time is within a first predetermined period of time of the publication time and when a challenge to the electronic tearsheet has not been received from the advertiser within a second predetermined time after the submission time. The electronic tearsheet can evidence publication parameters associated with the advertising that was run in the printed publication.

In some implementations, the computer-implemented method can further include receiving a challenge from the advertiser asserting that the publication parameters are different than the offer parameters. In some implementations, the computer-implemented method can further include analyzing the challenge and resolving the challenge in favor of either the advertiser or the publisher. In some implementations, analyzing the challenge includes providing the offer parameters, the electronic tearsheet and the challenge to a human agent, and receiving input from the human agent indicating whether the challenge is to be resolved in favor of the publisher or the advertiser. In some implementations, analyzing the challenge includes applying computer-directed graphical analysis to the electronic tearsheet to identify the publication parameters.

In some implementations, the computer-implemented method can further include charging the advertiser the first amount and paying the publisher the second amount when the challenge is resolved in favor of the publisher. The second amount can be less than the first amount. The second amount can be larger when the submission time is within a bonus period of the publication time than when the submission time is after the bonus period has expired. In some implementations, the bonus period is shorter than the first predetermined period of time. In some implementations, the publisher is not paid when the challenge is resolved in favor of the advertiser. In some implementations, the computer-implemented method further includes comparing the identified publication parameters to the offer parameters, and charging the advertiser a first amount and paying the publisher a second amount when the publication parameters match the offer parameters. In some implementations, the computer-implemented method further includes receiving a challenge from the advertiser asserting that the received electronic tearsheet does not correspond to the advertising.

Receiving the offer from the advertiser can include receiving the offer through a first web-accessible graphical user interface (GUI) provided by the electronic advertising system, receiving the acceptance from the publisher can include receiving the acceptance through a second web-accessible GUI provided by the electronic advertising system, and receiving the electronic tearsheet from the publisher can include receiving the electronic tearsheet through a third web-accessible GUI provided by the electronic advertising system.

In some implementations, an apparatus includes an advertiser interface configured to receive from an advertiser an offer to pay for advertising to be run in a printed publication according to offer parameters that include a publication time; a publisher interface configured to receive from a publisher of the printed publication, an acceptance to run the advertising according to the offer parameters, and, at a submission time, an electronic tearsheet from the publisher; and a payment module for charging the advertiser a first amount and paying the publisher a second amount when the submission time is within a first predetermined period of time of the publication time and when a challenge to the electronic tearsheet has not been received from the advertiser within a second predetermined time of the submission time.

In some implementations, a computer-implemented method of providing an electronic advertising system includes receiving, via a first graphical user interface (GUI), input identifying a publisher of a printed publication that has available print ad space; via a second GUI, receiving input from an advertiser that comprises an offer to pay for advertising in the printed publication and according to offer parameters that include a publication time; via a third GUI, receiving input from the publisher comprising an acceptance of the offer; via a fourth GUI, receiving, at a submission time, a compliance report from the publisher that evidences publication parameters of the advertising; and charging the advertiser a first amount and paying the publisher a second amount when the submission time is within a first predetermined period of time of the publication time and when a challenge to the compliance report has not been received from the advertiser within a second predetermined time of the submission time.

In some implementations, the computer-implemented method further includes receiving, via a fifth GUI, a challenge from the advertiser that asserts a difference between the offer parameters and the publication parameters. The computer-implemented method can further include analyzing the challenge and resolving the challenge in favor of either the advertiser or the publisher. Analyzing the challenge can include applying computer-directed graphical analysis to the compliance report to identify the publication parameters. The computer-implemented method can further include providing, via a sixth GUI, information regarding pending advertisements associated with the publisher. The sixth GUI can provide revenue information for each of the pending advertisements, wherein the revenue information is automatically adjusted based on resolution of any corresponding challenge.

In some implementations, a computer-implemented method includes receiving, at a receipt time, an electronic tearsheet from a publisher confirming placement at a placement time of a print ad in a publication according to specified terms between the publisher and an advertiser, the specified terms including a bid amount; determining whether a challenge to the electronic tearsheet is received from the advertiser within a predetermined period of time after the receipt time; and when a challenge to the electronic tearsheet is not received from the advertiser within the predetermined time after the receipt time, collecting the bid amount from the advertiser and providing a publisher's share of the bid amount to the publisher.

Some implementations may provide one or more of the following advantages. An electronic advertising system may provide advertisers with new advertising markets and publishers with new advertising revenue. An electronic advertising system may facilitate an efficient and inexpensive method for publishers to provide electronic tearsheets as evidence that advertising was run according to agreed-upon parameters. An electronic advertising system may facilitate an efficient and inexpensive method for advertisers to verify that advertising was run according to agreed-upon parameters. Criteria for charging advertisers and paying publishers may incentivize accuracy and timeliness, which may lead to accounting efficiencies and increased revenue.

The details of various implementations are set forth in the accompanying drawings and the description below. Other features, objects, and advantages will be apparent from the description and drawings, and from the claims.

### DESCRIPTION OF DRAWINGS

FIG. 1 is a block diagram of an example electronic print ad management system.

FIG. 2 is a flowchart showing an example process for providing an electronic advertising system.

FIGS. 3A-D are example graphical user interfaces for advertisers associated with one implementation of an electronic advertising system.

FIGS. 4A-B are example graphical user interfaces for publishers associated with one implementation of an electronic advertising system.

FIG. 5 is a flowchart showing an example process for determining how a publisher should be paid for running an ad.

FIGS. 6A-6B are example graphical user interfaces to enable a publisher to upload an electronic tearsheet.

FIG. 7A is an example graphical user interface to enable an advertiser to monitor pending ads.

FIG. 7B is an example graphical user interface to enable an advertiser to challenge an electronic tearsheet.

FIG. 8 is an example graphical user interface to enable a publisher to monitor pending ads.

FIG. 9 is a schematic diagram of an example computer system.

Like reference symbols in the various drawings indicate like elements.

### DETAILED DESCRIPTION

Techniques, methods, apparatus and a system for advertising and advertising revenue management are described. The techniques, methods, apparatus and system can be used to facilitate print advertising (e.g., advertising occurring in print, such as, for example, in newspapers, magazines, journals, periodicals, flyers, brochures, and other printed publications).

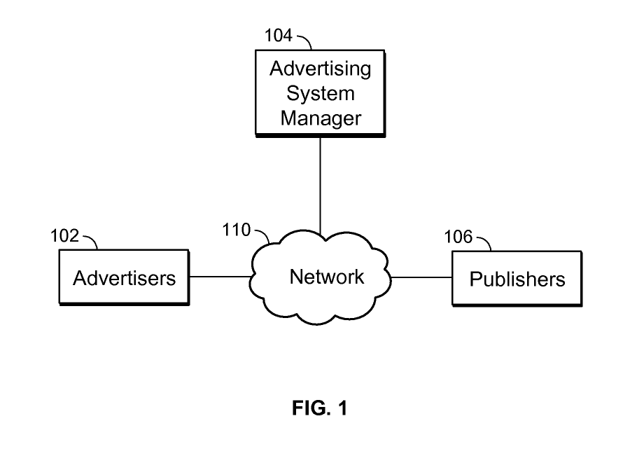

FIG. 1 is a block diagram of an example implementation of an electronic advertising system 100, such as, for example, an electronic print ad management system. The system 100 includes advertisers 102 and publishers 106. A publisher 106 can be an entity that publishes content (e.g., print ads) or places content for publication with another entity. By way of example, reference is made to placing print ads in a publication. Other forms of content can be delivered and published in accordance with the methods, apparatus and systems disclosed herein. An advertiser 102 can be an entity that desires to place a print ad in a printed publication. The advertiser 102 can be a direct supplier (e.g., an advertising entity) or an indirect supplier (e.g., a middle man) of print ads. The system further includes an advertising system manager 104. The advertising system manager 104 can operate to bring the advertisers 102 and publishers 106 together, for example, by way of an online print ad marketplace, as is described further below. A computer network 110, such as a local area network (LAN), wide area network (WAN), the Internet, or a combination thereof, can connect the advertisers 102, the advertising system manager 104 and the publishers 106.

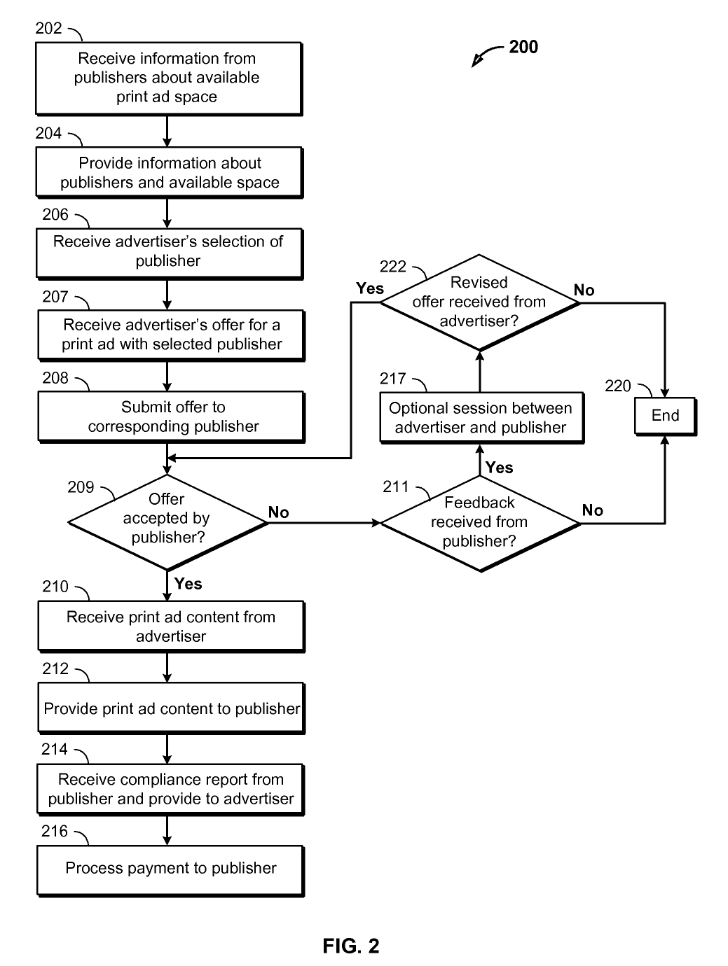

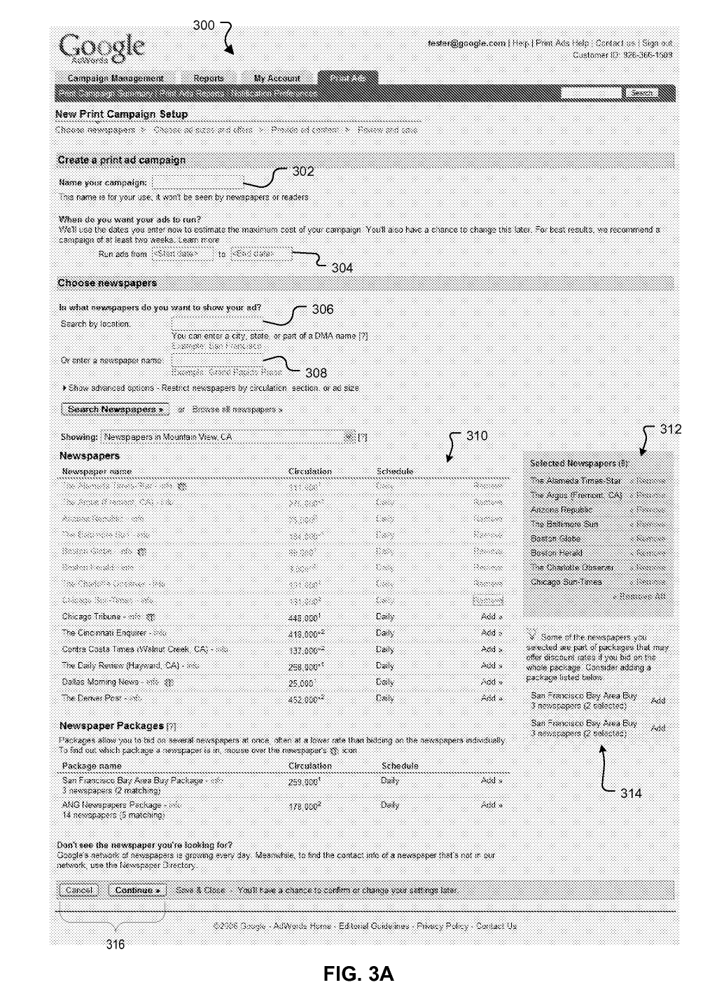

FIG. 2 is a flowchart showing an example process 200 for providing an electronic advertising system 100 (e.g., an online marketplace) for publishers 106 and advertisers 102, wherein one or more of the steps in the process can be carried out by, for example, the advertising system manager 104. Available print ad space is identified (step 202). For example, the publishers 106 can provide information to the advertising system manager 104 about available print ad space. The publisher information can include the name of the publication, the date or dates the publication is published, the location of the print ad space within the publication, the size and layout of the print ad space, whether the print ad will be run in black and white, color or either, and/or other information the publisher desires to provide to market their available print ad space.

Information associated with the publishers of the available print ad space is provided (step 204). For example, the advertising system manager 104 can provide an online marketplace in which publisher information provided by the publishers 106 is made available to the advertisers 102. In one implementation, the online marketplace is a web site. In this implementation, an advertiser 102 can be presented with a graphical user interface (GUI) through which the advertiser 102 can input certain choices about publishers with whom they would like to place ads. For example, the GUI can include checkboxes, drop-down menus, radio controls, data entry fields, and/or other user input controls or combinations thereof. In one implementation, the web site includes search capabilities. For example, if an advertiser 102 would like to search for a newspaper in a particular geographic location, the advertiser 102 can use the search capabilities to identify one or more newspapers meeting the advertiser's 102 geographic criteria, although a search query can be based on different and/or other search criteria as well.

An advertiser selects one or more publishers that the advertiser is interested in placing a print ad with (step 206). For example, using the web site provided by the advertising system manager 104, the advertiser 102 can provide input to the advertising system manager 104 to choose one or more publishers 106 that the advertiser 102 is interested in placing ads with based on publisher information included on the web site. By way of illustrative example, consider an advertiser 102 that is interested in placing a print ad in a newspaper. In this example the publishers 106 are newspapers. The advertiser 102 can choose certain newspaper publishers 106, for example, based on factors such as geography, circulation size, ad size availability, section availability and other criteria. To the extent that a publisher 106 has provided publisher information relevant to these factors to the advertising system manager 104, the advertiser 102 can access this information, through the advertising system manager 104, when choosing the newspaper publishers 106.

The advertiser creates an offer for one or more print ads with the selected publishers and can submit the offer to the advertising system manager, which receives the offer (step 207). The offer can include the specific terms associated with the advertisement including the price that advertiser is willing to pay for placing the ad. For example, the advertiser 102 can select various parameters related to the desired advertising, such as the day(s)-of-week, desired newspaper section and ad size for each chosen newspaper publisher 106. The advertiser 102 can input a “bid amount” (e.g., a price the advertiser 102 is willing to pay to place an ad of the selected ad size in the chosen newspaper section on the selected day or days of the week). In some implementations, the advertiser's input, including the bid amount, constitutes the advertiser's “offer.”

In step 208, offers are submitted to corresponding publishers. For example, the advertising system manager 104 can submit the advertiser's offers to the corresponding publishers 106. In some implementations, submitting the offers can include sending an electronic message to the publishers that includes information about the offers. In some implementations, submitting the offers can include making the information about the offers available on a portion of a web site maintained by advertising system manager 104, which may be accessibly only by appropriate publishers. In some implementations, submitting the offers can include making the offers available on a particular portion of the web site and notifying the appropriate publishers of the availability of the offers by electronic message. Each publisher 106 can respond by either accepting or declining the offer. In one implementation, a publisher 106 can decline an offer but initiate an online (or offline) dialog with the advertiser 102 as to why the offer was not accepted and the two parties can attempt to reach an agreement satisfactory to both parties (step 217)

If an offer is accepted (“Yes” branch of decision step 209), the print ad can be submitted (step 210). For example, the advertiser 102 can electronically submit corresponding print ad content to the publisher 106. Alternatively, the advertiser can supply print ad content with the offer. In one implementation, the advertiser 102 uploads an electronic file including the print ad content to the advertising system manager 104 and the advertising system manager 104 provides the electronic file to the publisher 106 (step 212).

If an offer is declined (“No” branch of decision step 209), a check can be made to determine if publisher feedback has been received (step 211). If so (“Yes” branch of decision step 211), an optional session between the advertiser and publisher can be initiated (step 217), during which, for example, the advertiser and publisher can continue negotiating terms associated with an ad placement. If no publisher feedback has been received (“No” branch of decision step 211), the process 200 can terminate (step 220). For example, if the publisher provides no comments or feedback to the advertiser 102 as to why the offer was declined, then the process terminates. However, if the publisher 106 does provide feedback to the advertiser 102, the advertiser 102 may be motivated to provide a revised offer (“Yes” branch of decision step 222), and the process returns to decision step 209. Otherwise, if the advertiser 102 does not provide a revised offer (“No” branch of decision step 222), the process terminates (Step 220).

Step 214 includes submission of a compliance report (e.g., an electronic tearsheet) by the publisher and receipt of the same by the electronic advertising system. For example, once the publisher 106 has run the ad (e.g., run the ad in the desired section in the newspaper on the selected date), the publisher 106 can provide proof that the ad ran to the advertising system manager 104. In one implementation, an electronic tearsheet can be uploaded to the electronic advertising system as proof that the ad ran according to agreed-upon terms. The electronic tearsheet can be an electronic file that includes an image of the ad as placed within the publication and can include enough information to show that the ad ran in the desired section of the newspaper on the selected date and according to any other specifications of the advertiser, e.g., ad size, ad color, font size, etc. In one implementation, the electronic tearsheet is a PDF file including a scanned representation of the page of the publication on which the ad ran.

Once an electronic tearsheet is uploaded by the publisher 106 to the advertising system manager 104, the advertising system manager 104 can provide the electronic tearsheet to the advertiser 102. For example, the advertising system manager 104 can forward the electronic tearsheet to the publisher by electronic message, by making the electronic tearsheet accessible in a portion of a web site to which the publisher has access, through a combination of providing access and sending an electronic messages, etc.

Once the advertising system manager 104 determines that the ad ran (e.g., by receiving an electronic tearsheet), the advertising system manager 104 can collect a bid amount from the advertiser 102 (Step 216) and transmit a publisher's share of the collected bid amount to the publisher 106 (Step 216).

In some implementations, as described in greater detail with reference to subsequent figures, an advertiser 102 can challenge the electronic tearsheet within a specified period of time after the electronic tearsheet is uploaded. In particular, the advertiser 102 can, in some implementations, send a challenge message to the advertising system manager 104. The advertising system manager 104 may forward the challenge message to the publisher 106, or the advertising system manager 104 may resolve any challenge raised by the advertiser directly (e.g., in an automated manner, or with human involvement, or with a combination of both). In some implementations, if it is determined that the ad was not run according to agreed-upon parameters, the bid amount may not be collected from the advertiser 102, and neither the advertising system manager 104 nor the publisher 106 may receive payment.

In some implementations, the advertising system manager 104 automates many if not all steps in the process of either placing ads (e.g., steps taken by an advertiser 102) or selling ad space (e.g., steps taken by a publisher 106). For example, the advertising system manager 104 can automatically provide matches between advertisers 102 and publishers 106 based on their respective inputs (e.g., the advertisers' offers and the publishers' information). Further, the advertisers 102 can be provided with an electronic mechanism for uploading and transmitting the ad content to the publishers 106. The publishers 106 can be provided with an electronic mechanism for proving the ad was placed as agreed (e.g., in the form of an electronic tearsheet). Once both parties are satisfied their terms of the agreement (subject in some implementations to mediation by the advertising system manager 104), payment (e.g., the bid amount) can be automatically collected from the advertiser 102 and the publisher can be provided with the publisher's share of the bid amount.

Advantageously, in some implementations, the advertiser 102 is provided with a central mechanism (e.g., the advertising system manager's website) to access available print ad space of, for example, multiple publishers. Correspondingly, the publishers 106 can be provided with a marketplace for their available print ad space. The payment mechanism (e.g., a bid system) can enable the advertiser 102 to only pay what the advertiser 102 decides to pay, and the publisher 106 can choose to accept only offers that are most desirous to the publisher 106.

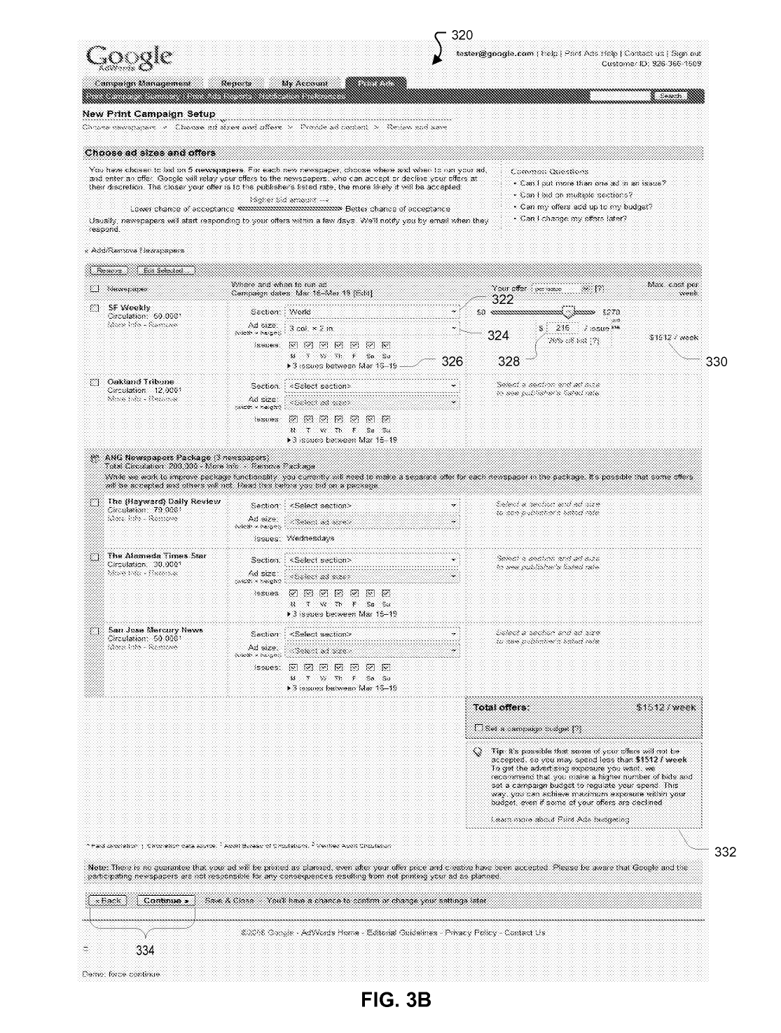

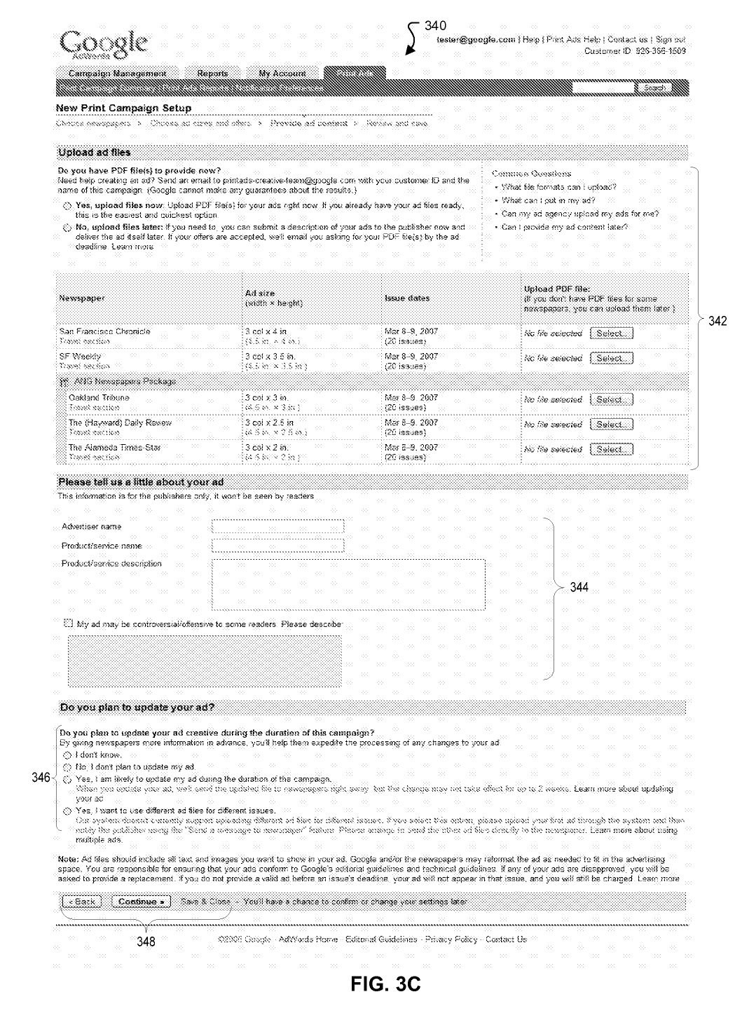

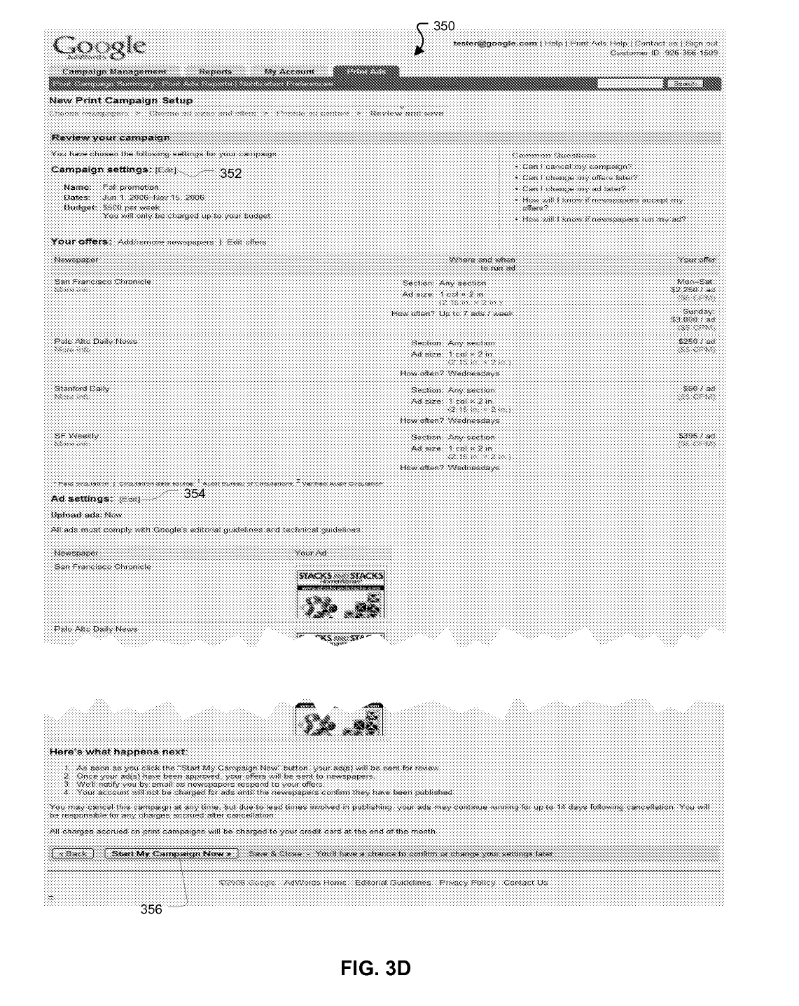

Referring now to FIGS. 3A-D, example GUIs of an example web site configured to implement an electronic advertising system. The GUIs shown in these figures are directed to the advertisers 102 and can be used to receive the advertisers' offers. These GUIs are illustrative examples, and other configurations can be used.

Referring particularly to FIG. 3A, a GUI 300 is shown for one example that enables an advertiser 102 to create offers to place print ads with newspaper publishers 106. As shown in one implementation, data fields 302 and 304 are provided through which the advertiser 102 can input a name for a print ad campaign being created (e.g., a set of offers) and the desired start and end dates for the ad campaign.

The advertiser 102 can choose to either search for names of newspapers by location using the search input field 306, or can enter a newspaper name into the data field 308. Other controls are provided for the advertiser 102 to search, for example, newspapers per the search criteria entered in the data fields, or by use of a drop-down menu. A list of newspapers is provided to the advertiser 102, and in this example, the advertiser 102 has selected the first eight newspapers from the list 310. A data box 312 shown to the right of the list can identify for the advertiser 102 the names of the newspapers selected and can include a “remove” control, which the advertiser 102 can select to remove one or more newspapers from the list.

As shown in one implementation, a second data box 314 can provide additional information to the advertiser 102 about certain of the selected newspapers. For example, as shown, the advertiser 102 is notified that some of the newspapers selected are a part of packages that offer discount rates if the advertiser bids on the whole package. Suggested packages to add to the list of selected newspapers are proposed to the advertiser 102. Near the bottom of the GUI 300 control buttons 316 are provided for the advertiser 102 to cancel or continue with inputting information to create offers.

Referring now to FIG. 3B, a next GUI 320 is shown that can presented to the advertiser 102 upon selecting the continue control 334 shown in FIG. 3A. In particular, as shown in one implementation, the GUI 320 can display each of the newspapers selected by the advertiser 102 using the previous GUI 300, along with a set of user controls. The advertiser 102 can employ the user controls to input specifics about an offer for each particular publisher 106 (e.g., newspaper). In the example implementation shown, the advertiser 102 is prompted to input the section 322 of the newspaper in which to run the print ad, the ad size 324, and the issues 326 (e.g., for a daily publication, the day(s) of the week). The advertiser 102 is also prompted to input a bid amount 328. A column to the right of the bid amount shows a calculated maximum weekly cost 330, based on the bid amount and the number of days selected.

A data box 332 can provide suggestions or additional information to the advertiser. In particular, in the example shown, the data box 332 advises the advertiser 102 that some of the advertiser's offers may not be accepted, resulting in the advertiser spending less than a calculated “maximum cost per week” amount shown; in this example, the data box 332 recommends that the advertiser make a higher number of offers and set a campaign budget (e.g., using another interface, which is not shown) to regulate the advertiser's spending. The recommendation can be based on historical results from previous bids that were accepted for similar print ads (e.g., similarly sized ads in a similar location, publication, etc.). In some implementations, such a technique can assist the advertiser in achieving maximum advertising exposure within a specified budget, even if some of the advertiser's offers are subsequently declined. That is, by setting a specified budget (e.g., with another GUI, not shown) and submitting bids that total more than the specified budget, an advertiser may be more likely to spend all of a specified advertising budget when less than all of the submitted bids are subsequently accepted. Control buttons 334 can allow the advertiser 102 to go back to the previous GUI 300, continue or “save and close”.

FIG. 3C illustrates an example GUI 340 that can be displayed when the advertiser selects the continue control 334 in the GUI 320 shown in FIG. 3B. In particular, the advertiser 102 can use controls 342 to upload files including the print ad content the advertiser 102 desires to place in one or more of the selected newspapers. In this implementation, data fields 344 are provided through which the advertiser 102 can provide information for the publishers 106, including the advertiser's name, product/service name, product/service description, and a description of persons who may find the ad content controversial or offensive. As shown in one implementation, controls 346 are provided for the advertiser 102 to indicate whether they plan to update their ad and/or use different ad files for different issues. For example, the advertiser 102 may upload one ad file for use in issues published from Monday to Friday and a second ad file for use in issues published on the weekend. Controls 348 allow the advertiser 102 to go back to the previous GUI 320, continue or save and close.

FIG. 3D illustrates an example GUI 350 that can be displayed when the advertiser selects the continue control 348 in the GUI 340 that is shown in FIG. 3C. In this example, the advertiser 102 is presented with a summary of the ad campaign the advertiser 102 has created, including a summary of the advertiser's offers and the ad content uploaded in the ad files. The advertiser 102 can select “edit” controls 352 and 354 to edit the advertiser's offers and ad content. If the advertiser 102 is satisfied with the ad campaign as shown, the advertiser 102 can select the “start my campaign now” button 356 to initiate consideration of the offers by the corresponding publishers 106. In some implementations, the advertiser 102 is notified by email from the advertising system manager 104 as newspaper publishers 106 respond to the advertiser's offers.

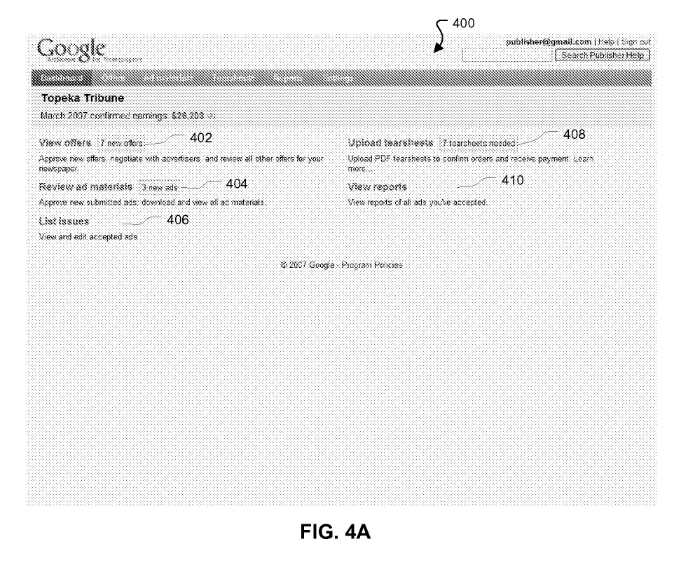

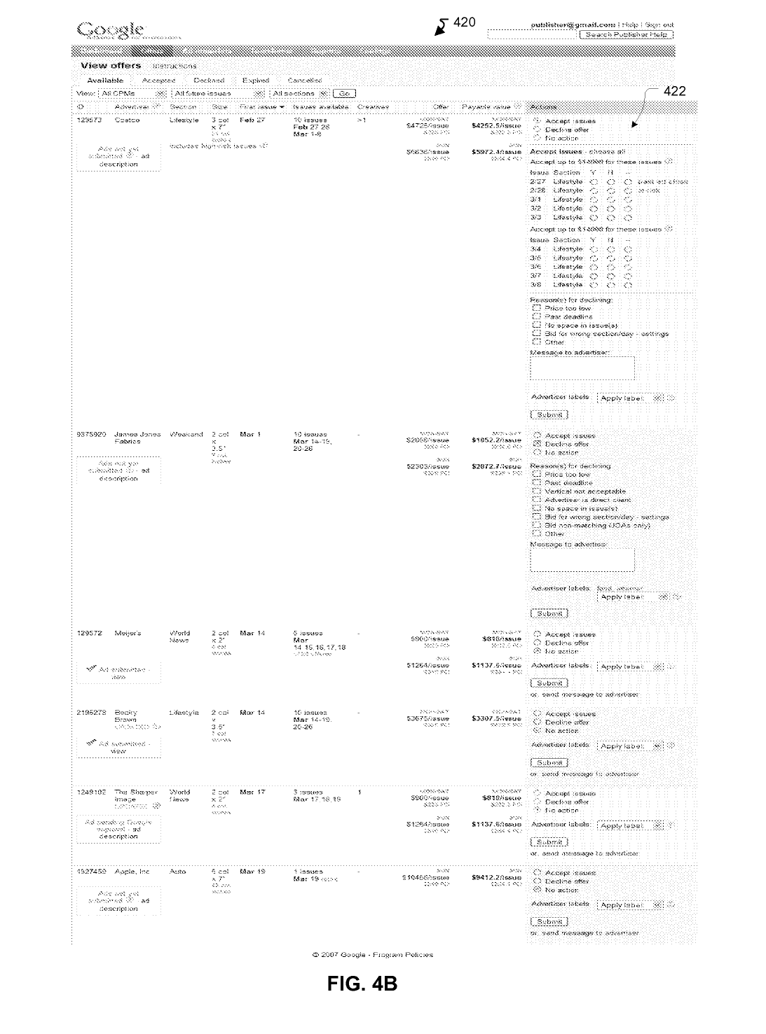

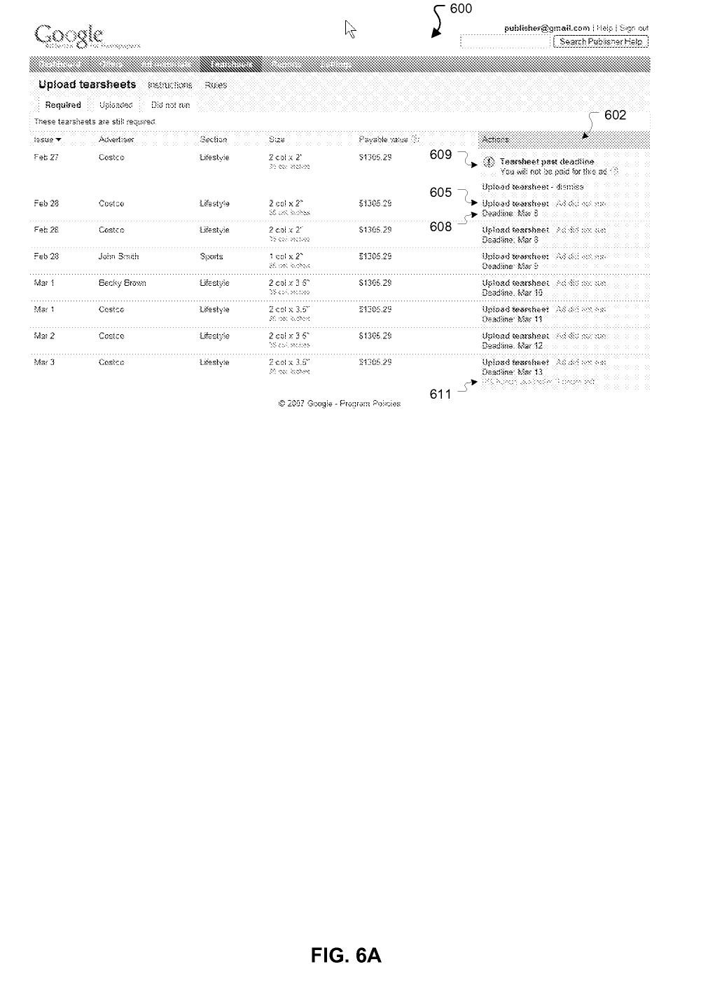

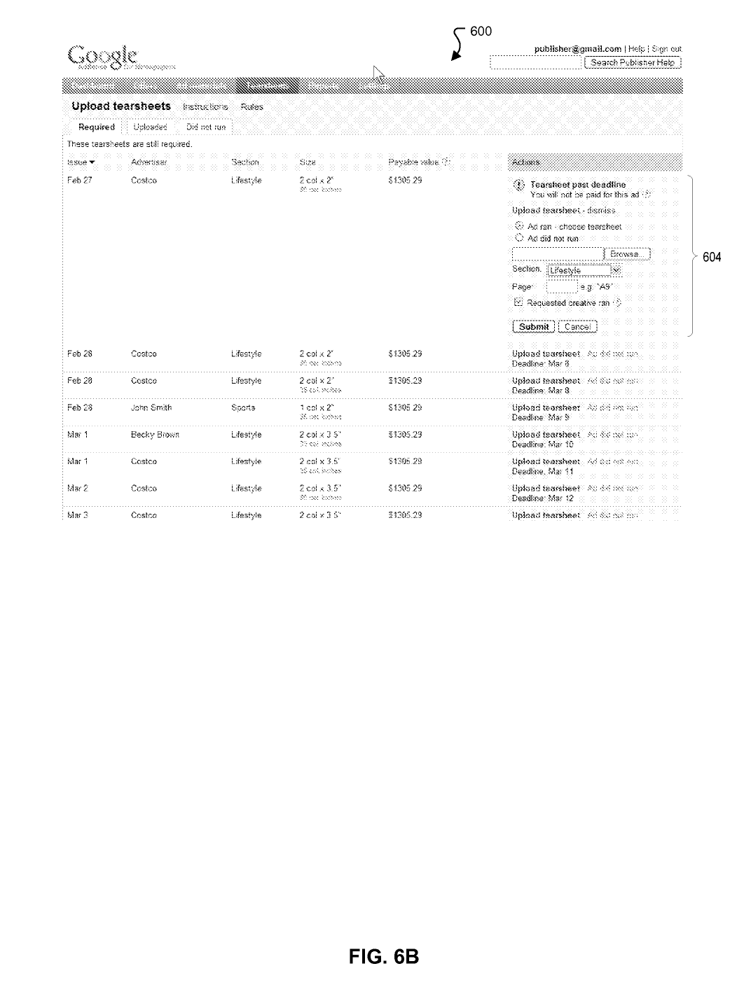

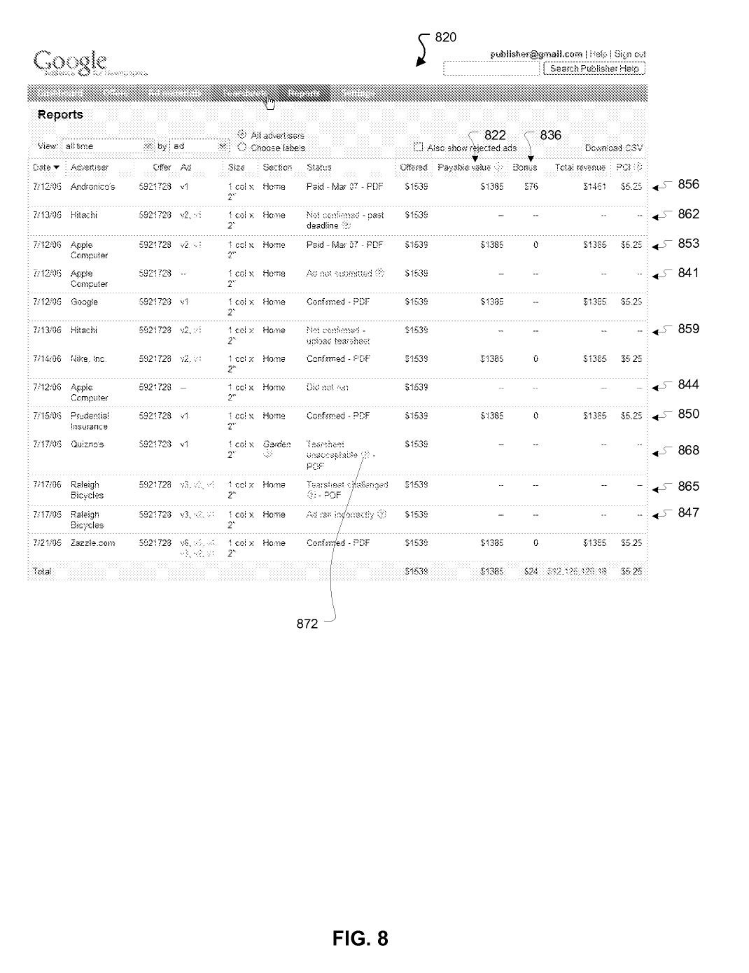

FIGS. 4A-B illustrate example GUIs that, in some implementations, are directed to the publishers 106. These GUIs are illustrative examples, and other configurations can be used. FIG. 4A shows a GUI 400 that provides example content directed to a specific publisher 106, in this example, the Topeka Tribune. As shown in this example, the publisher 106 is provided with a summary of offers received 402 (“7 new offers”) and a link to another web page to view the offers (see FIG. 4B). The publisher 106 can be provided with a summary of ad materials for review 404 (“3 new ads”) and a link to download and view the ad materials. A link to a list of issues 406 can be provided to enable the publisher to view and edit accepted ads. A summary of tearsheets needed can also be provided 408 (“7 tearsheets needed”), along with a link to another GUI for uploading PDF tearsheets. Example facilities for uploading tearsheets are described in detail with reference to FIGS. 6A-6B. A link for viewing reports 410 can also be provided, from which the publisher 106 can view reports of all ads the publisher 106 has accepted. Example reports are described in detail with reference to FIG. 8.

Referring to FIG. 4B, an example GUI 420 is shown that can be presented upon the advertiser 102 clicking the view offers 402 link shown in FIG. 4A. As shown in this example, each offer received is detailed and an action column 422 is provided to enable the publisher to take various actions with respect to offers. In particular, for example, the publisher 106 can input selections into controls and data fields included in the action column 422 to accept an offer, decline an offer and/or to provide reasons for declining an offer and an optional message to the advertiser 102.

After a publisher accepts an offer to run an ad (and subsequently publishes the ad), the publisher is generally paid. In some implementations, the advertising system manager 104 facilitates payment. In particular, the advertising system manager 104 can charge the advertiser for an ad that was run and pay the publisher for running the ad. Before payment is processed, the advertising system manager can verify, or help the advertiser verify, that an ad was run according to terms previously agreed upon by the advertiser and the publisher. In some implementations, as described above, the publisher can upload an electronic tearsheet to the advertising system manager 104 as evidence that an ad was correctly run, and the advertiser can view the uploaded electronic tearsheet to verify the same.

To facilitate an efficient upload process, the advertising system manager 104 can be configured to pay a publisher for an ad only if publisher uploads a corresponding electronic tearsheet within a certain period of time. The advertising system manager 104 can provide a method for advertisers to challenge ads that were incorrectly run, or for which a proper tearsheet was not provided. To facilitate efficient review of tearsheets by an advertiser, the advertising system manager 104 can be configured to automatically bill the advertiser upon the expiration of a predetermined period of time (e.g., a challenge period), if the advertiser has not submitted a challenge within the predetermined period of time. In this manner, an electronic advertising system can provide advertisers with efficient access to advertising space, publishers with efficient access to advertisers, and both publishers and publishers with an efficient, predictable system in which disputes can be quickly handled and accounts can be quickly settled.

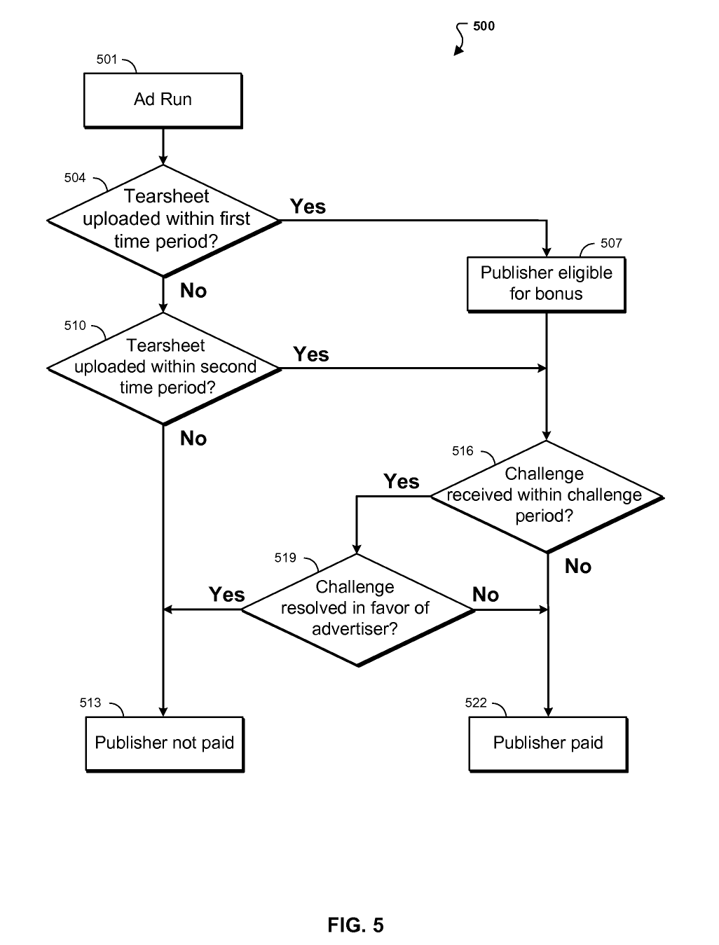

FIG. 5 is a flowchart showing an example process 500 for determining whether and how a publisher should be paid, including providing an advertiser with an opportunity to challenge an ad that was incorrectly run. After a publisher runs an ad (box 501), the publisher can upload a tearsheet (or other compliance report) as evidence that the ad ran. In some implementations, the process 500 can enforce one or more deadlines by which the publisher is to upload a tearsheet in order to be paid. For example, in some implementations, a publisher is incentivized to upload a tearsheet within a first period of time (determination of which is depicted by decision box 504), such as 24 or 48 hours from publication of the ad. In particular, for example, in some implementations, the publisher is eligible for a bonus (box 507) if the electronic tearsheet is uploaded within the first time period. In some implementations, the bonus is a monetary bonus payment. In other implementations, other bonus incentives are provided. For example, the publisher's future rates for the advertiser may be adjusted in favor of the publisher, or a rating for the publisher may increase within the electronic advertising system.

The publisher may be further incentivized to upload the electronic tearsheet within a second, longer period of time (determination of which is depicted by decision box 510). In particular, in some implementations, the publisher is not paid at all (box 513) if an electronic tearsheet is not uploaded within the second period of time (e.g., 7 days, 14 days, days, etc.). Other details related to charging an advertiser and paying a publisher are described further in U.S. patent application Ser. No. ______, entitled “Electronic Advertising System,” filed by Leader et al., on May 24, 2007, the entire contents of which are hereby incorporated by reference.

If the publisher uploads an electronic tearsheet within either the first or second period (depicted by the “Yes” branch in either step 504 or 510, respectively), the advertiser can be provided with a challenge period within which to challenge the electronic tearsheet. In some implementations, the challenge period is seven days from the time a corresponding electronic tearsheet is available; in other implementations, the challenge period is a different length of time. In some implementations, the challenge period can be fixed to provide predictability for publishers, and incentives for advertisers to promptly raise legitimate challenges. Absent a challenge by the advertiser within the challenge period, the publisher can be paid (box 522).

If the advertiser challenges an electronic tearsheet within the challenge period, the challenge can be resolved. If the challenge is resolved in favor of the publisher (“No” branch of decision box 519), the publisher can be paid (box 522); if the challenge is resolved in favor of the advertiser (“Yes” branch of decision box 519), the publisher, in some implementations, is not paid (box 513).

In some implementations, human agents can resolve challenges. For example, when an advertiser challenges an ad, a human agent can review the agreed-upon ad terms and the electronic tearsheet to determine whether the ad was run according to the agreed-upon terms. In some implementations, the publisher is only paid if the parameters of the ad that ran exactly match the agreed-upon parameters. That is, even minor deviations from agreed-upon terms can result in the publisher not being paid at all—regardless of whether the deviations harm or benefit the advertiser. Such a policy can promote predictability in the payment process and can encourage publishers to maintain high quality standards for ads received through the electronic advertising system. In other implementations, a publisher can be paid a reduced amount (e.g., 50% of the bid amount, 25% of the bid amount, some other predetermined percentage or fixed amount, etc.).

In some implementations, challenges can be resolved, at least in part, automatically (e.g., based on electronic inputs from the advertiser and publisher). For example, the advertising system manager 104 can employ automated graphical analysis to identify, from the electronic tearsheet, a size of an ad, a section corresponding to a page of the newspaper or other publication that is depicted by the electronic tearsheet, and specific content of the ad. The advertising system manger 104 can then compare the graphically identified ad parameters with agreed-upon parameters. If the graphically identified parameters match the agreed-upon parameters, the publisher can be paid; if not, the publisher may not be paid. In some implementations, challenges can be initially analyzed automatically, but portions of the review process (e.g., the final determination regarding payment) may be made by a human agent.

FIGS. 6A and 6B illustrate an example GUI 600 that a publisher can employ to upload an electronic tearsheet. This GUI is an illustrative example, and other configurations can be used. In some implementations, the GUI 600 is presented to a publisher when the publisher selects the “Upload tearsheets” control 408 that is shown in FIG. 4A. The example GUI 600 displays a list of eight ads that the publisher 106 previously agreed to place. Various information about each ad can be displayed, such as an advertiser who submitted the ad and agreed-upon publication parameters, such as a publication date for the ad, the section in which the ad is to be run, its size, and a value for accurate publication of the ad.

An action column 602 can provide additional information to the publisher regarding deadlines for submitting tearsheets, and can provide facilities for uploading the tearsheets to the electronic advertising system. In the example shown the action column 502, a control 605 (e.g., a hyperlink) is provided for each ad, which the publisher can select to upload a corresponding tearsheet. Information regarding a deadline for uploading the tearsheet can be displayed. For example, in some implementations, a deadline date 608 for uploading a tearsheet is displayed (e.g., corresponding to the end of the second period that is described with reference to FIG. 5). If the publisher has not uploaded a required tearsheet before the deadline date, a message 609 can be displayed notifying the publisher that that deadline has past and further indicating, in some implementations, that the publisher will not be paid for the ad because of missing the deadline. In implementations in which a publisher can earn a bonus for submitting an electronic tearsheet in advance of the final deadline, information can be provided regarding an earlier bonus deadline 611 (e.g., corresponding to the end of the first period that is described with reference to FIG. 5).

FIG. 6B illustrates additional controls 604 that can be provided, for example, upon the publisher's selection of the upload tearsheet control 605 that is shown in FIG. 6A. As shown in one implementation, the additional controls can include controls for browsing for and selecting an electronic tearsheet and input controls to allow the publisher to self-report publication parameters, such as the section and page on which the ad ran, whether the requested creative was used (e.g., as provided by the advertiser, without any modification). The controls 604 can also include input controls (e.g., radio buttons, as shown, checkboxes, etc.) to allow the publisher to indicate that a particular ad did not run. Upon identification of an appropriate tearsheet and input of various publication parameters, the publisher can submit the electronic tearsheet using a submit control. Once submitted, the electronic tearsheet can be made available to the corresponding advertiser through a GUI directed to the advertiser, an example of which is now described in further detail.

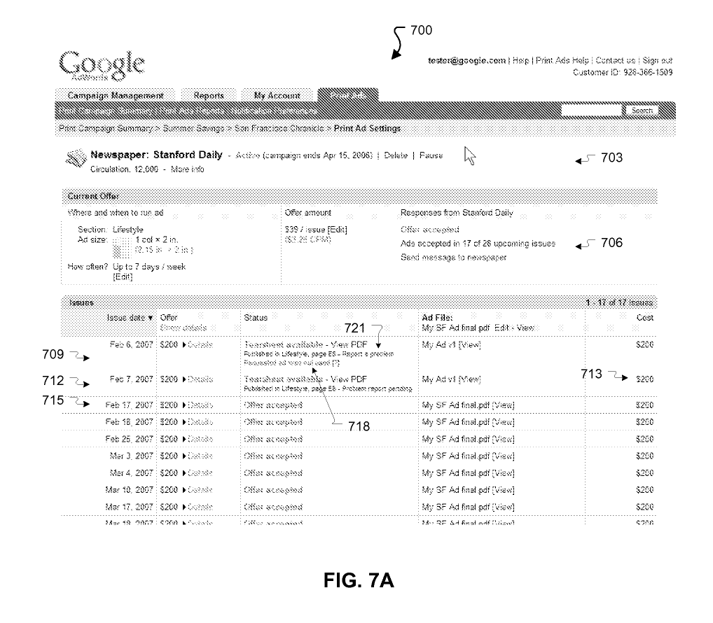

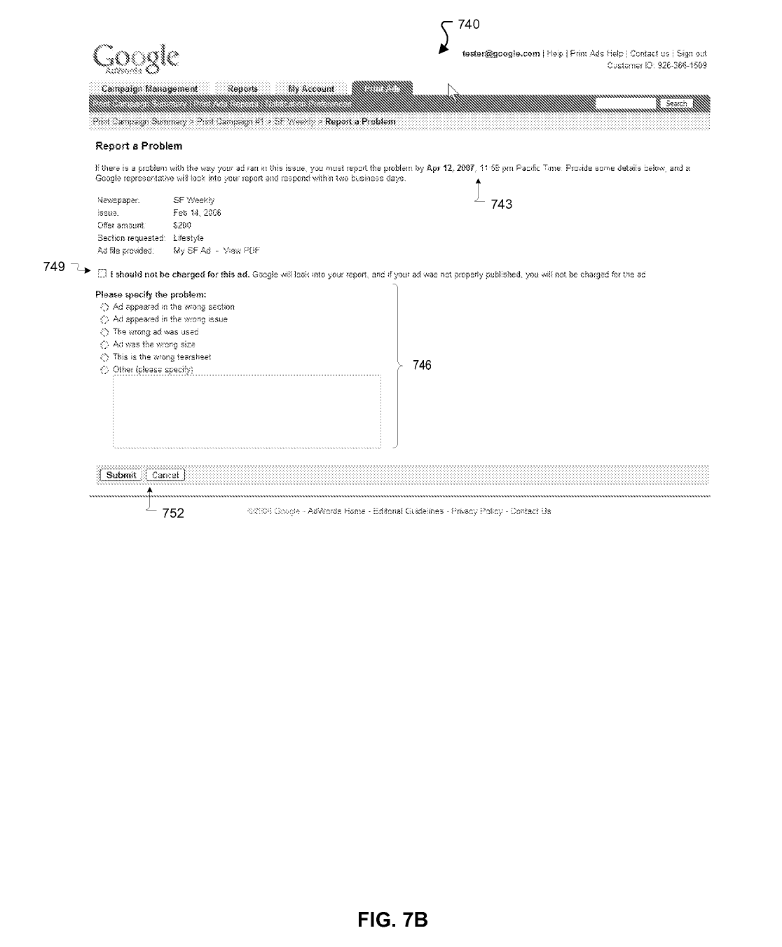

FIG. 7A illustrates an example GUI 700 that can be displayed to advertisers, for example, to monitor pending ads with a particular publication. In this example, an interface is displayed that summarizes an advertiser's pending ads with the Stanford Daily. As shown, information can be displayed about the section in which the ad is to be run, its size, days or dates on which the ad is to be run, the offer amount, and details about acceptance of the offer. In some implementations, the original offer is open-ended as to some offer parameter (e.g., a number of issues in which to run that ad, specific days or dates on which to run the ad, etc.), and only a portion of the total possible offer is accepted; in such implementations, information regarding the accepted portion of the offer can be displayed. In particular, as indicated in the example in FIG. 7A, ads were accepted in 17 of 28 upcoming issues.

In some implementations, for each accepted ad (e.g., each separate ad campaign, or each individual ad within an ad campaign), status information can be displayed. The status information can include a date for a specific ad; offer details for that specific ad; an indication of whether a tearsheet is available, and if so, a control to enable the advertiser to view the tearsheet; and other status information about publication of the ad (e.g., to report deviations between the ad as-run and agreed-upon parameters for the ad). The status information can include, for example, an indication by the publisher of where the ad was run (e.g., Lifestyle section, page E8) and whether the requested ad creative used. In some implementations, this status information can be supplied by the self-reported information provided by the publisher when the tearsheet is uploaded (e.g., using controls such as the controls 604 shown in FIG. 6B). In other implementations, the status information can be determined by the electronic advertising system (e.g., through automated graphical analysis of an electronic tearsheet and subsequent comparison of identified information and agreed-upon ad parameters).

As a specific example, the status entry 709 indicates that a tearsheet is available for viewing, that the corresponding ad ran in the Lifestyle section on page E8, and that the requested ad creative was not used (status message 718). A control can be provided to enable the advertiser to view the electronic tearsheet, and another control can be provided to enable the advertiser to report a problem. The status entry 709 can further display an offer price for the ad, a control for accessing additional details related to the offer, a control for viewing an ad creative that was previously submitted for publication, and a cost for the ad. In some implementations, the cost is a default cost (e.g., the accepted offer amount) that assumes no challenge will be raised by the advertiser and ultimately resolved in favor of the advertiser. In some implementations, the cost is updated when a challenge is submitted and resolved in favor of the advertiser. For example, the status entry 712 depicts an ad for which a challenge (e.g., “Problem report”) is pending. If the challenge is subsequently resolved in favor of the advertiser, the cost 713 can be updated (e.g., to $0).

In some implementations, the cost can also be updated if the publisher does not upload an electronic tearsheet within a required period of time. For example, the status entry 715 indicates that an offer has been accepted, but no tearsheet is available (e.g., as indicated by the absence of a “tearsheet available” message or control). If the publisher fails to upload a tearsheet within the required time, a status message can be provided (e.g., “No tearsheet provided by deadline”) and the cost can be updated (e.g., to $0). When an advertiser selects the control 721 to report a problem, another GUI can be provided, which is now described.

FIG. 7B illustrates a GUI 740 that can be provided in response to an advertiser's selection of a challenge control (e.g., the “Report a problem” control 721 that is shown in FIG. 7A). The GUI 740 can provide various information about an ad, such as the newspaper (or other printed publication) in which the ad was to run, the issue date, a requested section, a control to display the submitted ad creative, etc. A challenge deadline 743 can also be displayed, which can alert the advertiser of a date or time by which a challenge must be submitted (e.g., 10 days from the date on which an electronic tearsheet is available, 14 days, 30 days, etc.). In some implementations, if the advertiser does not submit a challenge by the challenge deadline, the advertiser is automatically billed for the ad-even if the ad was not run according to the offer parameters. In such implementations, advertisers may be motivated to promptly review tearsheets once they are available.

The GUI 740 can include various input mechanisms 746 (e.g., radio buttons, check boxes, text-entry boxes, etc.) to enable an advertiser to report a problem. In the example shown, radio boxes are provided to enable the advertiser to flag that the ad appeared in the wrong section or issue, that the wrong ad was used or that the size was other than that the agreed-upon size. In this example, the advertiser can also flag some other issue with the ad and can provide a textual description of the issue in a text-entry box.

As shown in one implementation, a separate input 749 can be provided for the advertiser to explicitly dispute payment for an ad, separately from identifying deviations between publication parameters and agreed-upon parameters. The separate input 749 can enable the advertiser to flag deviations but still pay for the ad (e.g., in cases where the deviations benefited the advertiser and the advertiser wishes to pay in order to maintain goodwill with the publisher). In some implementations, any deviations, whether they hurt or help the advertiser, result in the advertiser not paying for the ad. Such a policy can be implemented to encourage accuracy on the part of publishers.

FIG. 8 illustrates another example GUI 820 that provides information to a publisher about ads that have run. In some implementations, the GUI 820 is displayed when a publisher selects the “View reports” control from a publisher's dashboard, which is depicted in and described with reference to FIG. 4A. The GUI 820 can display various information about ads that have run, including whether a challenge to a corresponding tearsheet has been submitted or resolved.

As shown in one example, the GUI 820 displays a number of status entries, each related to a different offer. Various example status entries are described. Status entry 841 depicts an accepted offer for which no ad creative was ever received. Status entry 844 depicts an ad that was accepted but did not run. Status entry 844 may result from the publisher self reporting that the ad did not run (e.g., through the “Ad did not run” radio button input shown in FIG. 6B). Status entry 847 depicts an ad that ran incorrectly (e.g., in the wrong section, at the wrong size, with a modified creative, etc.). Status entry 847 may result from the publisher self-reporting that the ad ran incorrectly or with a different creative than was supplied (e.g., through an absence of a check in the “Requested creative ran” checkbox shown in FIG. 6B). Status entry 850 depicts that an ad ran and payment has been confirmed (e.g., the tearsheet was submitted within the required period of time and no challenge was received during the challenge period). Status entry 853 depicts that a confirmed ad was paid for (e.g., payment was actually collected from the advertiser and paid to the publisher). Status entry 856 further depicts payment of a bonus (e.g., in response to the publisher uploading an electronic tearsheet early in the tearsheet submission period).

Status entry 859 depicts an ad that ran, for which an electronic tearsheet has not yet been uploaded, but for which the deadline has not yet passed. Status entry 862 depicts an ad that ran, for which an electronic tearsheet has not yet been uploaded, and for which the deadline has already passed. In this example, the publisher will not be paid for the ad, as indicated by the “--” entry in the “Payable value” column 832 of the GUI.

Status entry 865 depicts an ad that ran, for which a tearsheet has been uploaded and challenged by the advertiser within the challenge period. In this example, the challenge has not been resolved, so a payable value is still indicated. Status entry 868 depicts an ad that ran, for which a tearsheet was uploaded and challenged, where the challenge was resolved in favor of the advertiser. In this example, the tearsheet is marked as “unacceptable,” and no payable value is indicated.

In some implementations, various information in the GUI 820 can be expanded to display additional information or to navigate the publisher to a different GUI with other information. For example, selection of a question control (e.g., question mark icon 872) can cause additional information to be displayed (e.g., in a pop-up window) regarding a corresponding field. In particular, for example, user selection of the control 872 can cause additional information to be displayed that explains why the tearsheet was determined to be unacceptable. In addition, controls can be provided (e.g., selectable hyperlinks) that cause the GUI to display an ad, a tearsheet, or sorted information relating to a specific date or a specific advertiser. Moreover, various filtering options can be provided, as depicted at the top of the GUI 820, to allow, for example, the publisher to filter based on ads, time period or some other criterion.

Additional payment information can be displayed. For example, the GUI 820 displays a “payable value” column 822 that includes the bid amount payable to the publisher 106 for placing the ad and uploading the electronic tearsheet within the maximum allowable time period. The GUI 820 further displays a “bonus” column 836, which, as mentioned above, can indicate when the publisher 106 is entitled to a bonus share of the bid amount (e.g., due to prompt uploading of the electronic tearsheet within a certain specified bonus period).

The functional operations described in this specification can be implemented in digital electronic circuitry, or in computer hardware, firmware, software, or in combinations of them. Apparatus can be implemented in a computer program product tangibly embodied in a machine-readable storage device for execution by a programmable processor; and method steps can be performed by a programmable processor executing a program of instructions to perform functions by operating on input data and generating output.

Implementations can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; a magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

To provide for interaction with a user, a computer system can include a display device such as a monitor or LCD screen for displaying information to the user and a keyboard and a pointing device such as a mouse or a trackball by which the user can provide input to the computer system. The computer system can be programmed to provide a graphical user interface through which computer programs interact with users.

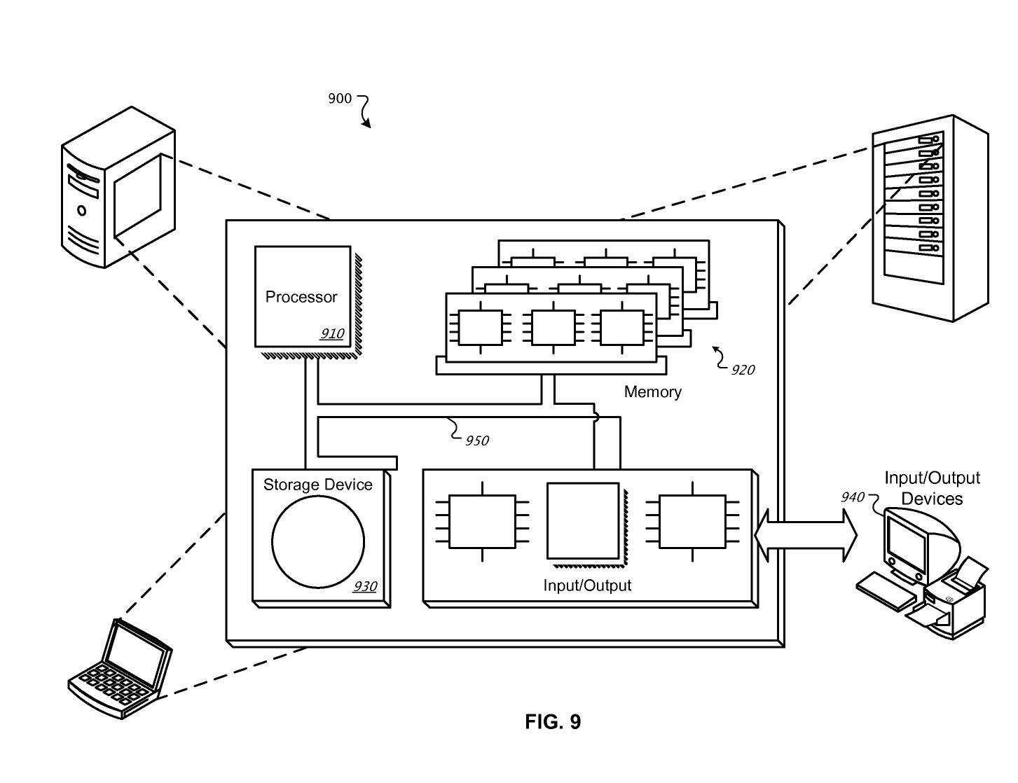

Referring now to FIG. 9, a schematic diagram of an example computer system 900 is shown. The system 900 can be used in some implementations, for example, to execute the operations described in association with the process 200 shown in FIG. 2 or process 500 shown in FIG. 5. As another example, one or more of the systems 900 can be used to implement a server hosting the advertising system manager 104, the advertisers 102 and/or the publishers 106 (see FIG. 1).

The system 900 includes a processor 910, a memory 920, a storage device 930, and an input/output device 940. Each of the components 910, 920, 930, and 940 can, for example, be interconnected using a system bus 950. The processor 910 is capable of processing instructions for execution within the system 900. In one implementation, the processor 910 is a single-threaded processor. In another implementation, the processor 910 is a multi-threaded processor. The processor 910 is capable of processing instructions stored in the memory 920 or on the storage device 930 to display graphical information for a user interface on the input/output device 940. In some embodiments, a parallel processing set of systems 900 connected over a network may be employed, clustered into one or more server centers.

The memory 920 stores information within the system 900. In one implementation, the memory 920 is a computer-readable medium. In one implementation, the memory 920 is a volatile memory unit. In another implementation, the memory 920 is a non-volatile memory unit.

The storage device 930 is capable of providing mass storage for the system 900. In one implementation, the storage device 930 is a computer-readable medium. In various different implementations, the storage device 930 can, for example, include a hard disk device, an optical disk device, or some other large capacity storage device.

The input/output device 940 provides input/output operations for the system 900. In one implementation, the input/output device 940 includes a keyboard and/or pointing device. In another implementation, the input/output device 940 includes a display unit for displaying graphical user interfaces.

A number of implementations have been described. Nevertheless, it will be understood that various modifications may be made without departing from the spirit and scope of the disclosed implementations. Accordingly, other implementations are within the scope of the following claims.

What is claimed is:

1. A computer-implemented method comprising:
receiving an offer to pay for advertising to be run in a printed publication according to offer parameters that include a publication time;
receiving an acceptance to run the advertising according to the offer parameters; receiving, at a submission time, an electronic tearsheet, the submission time being after the publication time of the advertising; and
charging a corresponding advertiser a first amount and paying a corresponding publisher a second amount when the submission time is within a first predetermined period of time of the publication time and when a challenge to the electronic tearsheet has not been received from the advertiser within a second predetermined time after the submission time.

2. The computer-implemented method of claim 1, wherein the electronic tearsheet evidences publication parameters associated with the advertising that was run in the printed publication.

3. The computer-implemented method of claim 2, further comprising receiving a challenge from the advertiser asserting that the publication parameters are different than the offer parameters.

4. The computer-implemented method of claim 3, further comprising analyzing the challenge and resolving the challenge in favor of either the advertiser or the publisher.

5. The computer-implemented method of claim 4, further comprising charging the advertiser the first amount and paying the publisher the second amount when the challenge is resolved in favor of the publisher.

6. The computer-implemented method of claim 4, wherein the second amount is less than the first amount.

7. The computer-implemented method of claim 6, wherein the second amount is larger when the submission time is within a bonus period of the publication time than when the submission time is after the bonus period has expired, wherein the bonus period is shorter than the first predetermined period of time.

8. The computer-implemented method of claim 4, wherein the publisher is not paid when the challenge is resolved in favor of the advertiser.

9. The computer-implemented method of claim 4, wherein analyzing the challenge comprises providing the offer parameters, the electronic tearsheet and the challenge to a human agent, and receiving input from the human agent indicating whether the challenge is to be resolved in favor of the publisher or the advertiser.

10. The computer-implemented method of claim 4, wherein analyzing the challenge comprises applying computer-directed graphical analysis to the electronic tearsheet to identify the publication parameters.

11. The computer-implemented method of claim 10, further comprising comparing the identified publication parameters to the offer parameters, and charging the advertiser a first amount and paying the publisher a second amount when the publication parameters match the offer parameters.

12. The computer-implemented method of claim 1, further comprising receiving a challenge from the advertiser asserting that the received electronic tearsheet does not correspond to the advertising.

13. The computer-implemented method of claim 1, wherein receiving the offer from the advertiser comprises receiving the offer through a first web-accessible graphical user interface (GUI) provided by the electronic advertising system, receiving the acceptance from the publisher comprises receiving the acceptance through a second web-accessible GUI provided by the electronic advertising system, and receiving the electronic tearsheet from the publisher comprises receiving the electronic tearsheet through a third web-accessible GUI provided by the electronic advertising system.

14. An apparatus comprising:
an advertiser interface configured to receive from an advertiser an offer to pay for advertising to be run in a printed publication according to offer parameters that include a publication time;
a publisher interface configured to receive from a publisher of the printed publication, an acceptance to run the advertising according to the offer parameters, and, at a submission time, an electronic tearsheet from the publisher; and
a payment module for charging the advertiser a first amount and paying the publisher a second amount when the submission time is within a first predetermined period of time of the publication time and when a challenge to the electronic tearsheet has not been received from the advertiser within a second predetermined time of the submission time.

15. A computer-implemented method of providing an electronic advertising system comprising:
via a first graphical user interface (GUI), receiving input identifying a publisher of a printed publication that has available print ad space;
via a second GUI, receiving input from an advertiser that comprises an offer to pay for advertising in the printed publication and according to offer parameters that include a publication time;
via a third GUI, receiving input from the publisher comprising an acceptance of the offer;
via a fourth GUI, receiving, at a submission time, a compliance report from the publisher that evidences publication parameters of the advertising; and
charging the advertiser a first amount and paying the publisher a second amount when the submission time is within a first predetermined period of time of the publication time and when a challenge to the compliance report has not been received from the advertiser within a second predetermined time of the submission time.

16. The computer-implemented method of claim 15, further comprising receiving, via a fifth GUI, a challenge from the advertiser that asserts a difference between the offer parameters and the publication parameters.

17. The computer-implemented method of claim 16, further comprising analyzing the challenge and resolving the challenge in favor of either the advertiser or the publisher.

18. The computer-implemented method of claim 17, further comprising charging the advertiser the first amount and paying the publisher the second amount when the challenge is resolved in favor of the publisher.

19. The computer-implemented method of claim 17, wherein the publisher is not paid when the challenge is resolved in favor of the advertiser.

20. The computer-implemented method of claim 17, wherein analyzing the challenge comprises applying computer-directed graphical analysis to the compliance report to identify the publication parameters.

21. The computer-implemented method of claim 17, further comprising providing, via a sixth GUI, information regarding pending advertisements associated with the publisher.

22. The computer-implemented method of claim 21, wherein the sixth GUI provides revenue information for each of the pending advertisements, wherein the revenue information is automatically adjusted based on resolution of any corresponding challenge.

23. A computer-implemented method comprising:
receiving, at a receipt time, an electronic tearsheet from a publisher confirming placement at a placement time of a print ad in a publication according to specified terms between the publisher and an advertiser, the specified terms including a bid amount;
determining whether a challenge to the electronic tearsheet is received from the advertiser within a predetermined period of time after the receipt time; and
when a challenge to the electronic tearsheet is not received from the advertiser within the predetermined time after the receipt time, collecting the bid amount from the advertiser and providing a publisher's share of the bid amount to the publisher.
